(19) United States
(12) Patent Application Publication
(10) Pub. No.: US 2022/0171185 A1
(43) Pub. Date: Jun. 2, 2022

(54) HEAD-UP DISPLAY FOR MITIGATING SOLAR LOADING AND BACK REFLECTION

(71) Applicant: GM GLOBAL TECHNOLOGY OPERATIONS LLC, Detroit, MI (US)

(72) Inventors: Thomas A. SEDER, Fraser, MI (US); Kai-Han Chang, Madison Heights, MI (US); Shailendra Kaushik, Novi, MI (US); Leslie G. Ferris, Clinton Township, MI (US); Guy N. Kennerly, Southfield, MI (US)

(21) Appl. No.: 17/106,782

(22) Filed: Nov. 30, 2020

(51) Int. Cl. G02B 27/01; G02B 5/30; G02B 5/00; G02B 5/02; G02B 27/28

(52) U.S. Cl. CPC G02B 27/0101; G02B 5/3083; G02B 5/003; B60K 35/00; G02B 27/281; G02B 2027/0118; G02B 5/0205

(57) ABSTRACT

A head-up display for a vehicle. The head-up display comprises a picture generating unit configured to project an image onto a glass surface and an optical stack. The optical stack comprises an infrared reflective waveplate and a dual brightness enhancement film. The infrared reflective waveplate transforms an incoming solar light beam from unpolarized light to incoming polarized light having an incoming S-polarization component and an incoming P-polarization component. The dual brightness enhancement film receives the incoming polarized light from the infrared reflective waveplate and eliminates substantially all of the incoming P-polarization component. The dual brightness enhancement film transmits substantially all of the incoming S-polarization component.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a head-up display (HUD) that displays information on a glass screen, such as the windshield of a motor vehicle (e.g., car, truck), a train, an aircraft, a boat, or the like. In a head-up display with high magnification optics, an excessive solar load may be projected into the picture generation unit (PGU) of the HUD and cause damage to the material. In addition, when the sunlight enters the light path of the HUD, the back-reflected sunlight from the PGU surface may follow the same light path and be seen by the driver. This back reflection reduces image contrast.

### SUMMARY

It is an object of the present invention to provide a head-up display comprising: i) a picture-generating unit configured to project an image onto a polarization-preserving diffusing surface; and ii) an optical stack comprising: iii) an infrared reflective waveplate; and iv) a dual brightness enhancement film. The infrared reflective waveplate reflects an infrared portion of a first incoming solar light beam and transmits a second incoming solar light beam having an S-polarization component and a P-polarization component.

In one embodiment, the dual brightness enhancement film receives the second incoming solar light beam from the infrared reflective waveplate and reflects substantially all of the P-polarization component of the second incoming solar light beam.

In another embodiment, the dual brightness enhancement film transmits substantially all of the S-polarization component received from the infrared reflective waveplate as a third incoming solar light beam having an S-polarization component.

In still another embodiment, the head-up display comprises a light absorber.

In yet another embodiment, the dual brightness enhancement film reflects substantially all of the P-polarization component by deflecting the P-polarization component towards the light absorber.

In a further embodiment, a plane of the dual brightness enhancement film is tilted with respect to the direction of the second incoming solar light beam.

In a still further embodiment, the head-up display further comprises a polarization preserving diffuser configured to receive the third incoming solar light beam having the S-polarization component from the dual brightness enhancement film and to transmit a first outgoing beam having an S-polarization component and a P-polarization component.

In a yet further embodiment, the S-polarization component of the first outgoing beam is significantly larger than the P-polarization component of the first outgoing beam.

In one embodiment, the dual brightness enhancement film receives the first outgoing beam from the polarization preserving diffuser and eliminates substantially all of the P-polarization component of the first outgoing beam.

In another embodiment, the dual brightness enhancement film transmits substantially all of the S-polarization component of the first outgoing beam as a second outgoing beam.

In still another embodiment, the dual brightness enhancement film eliminates substantially all of the P-polarization component of the first outgoing beam by deflecting the P-polarization component of the first outgoing beam towards the light absorber.

In yet another embodiment, the infrared reflective waveplate receives the second outgoing beam from the dual brightness enhancement film and transmits a third outgoing beam having an S-polarization component and a P-polarization component.

In a further embodiment, the S-polarization component of the third outgoing beam is significantly larger than the P-polarization component of the third outgoing beam.

It is an object of the present invention to provide a method of reducing solar load in a head-up display comprising a picture-generating unit configured to project an image onto a polarization-preserving diffusing surface. The method comprises in an optical stack comprising an infrared reflective waveplate and a dual brightness enhancement film: i) reflecting by the infrared reflective waveplate an infrared portion of a first incoming solar light beam; and ii) transmitting by the infrared reflective waveplate a second incoming solar light beam having an S-polarization component and a P-polarization component.

In one embodiment, the method further comprises: i) receiving in the dual brightness enhancement film the second incoming solar light beam from the infrared reflective waveplate; and ii) reflecting in the dual brightness enhancement film substantially all of the P-polarization component of the second incoming light beam.

In another embodiment, the method further comprises, in the dual brightness enhancement film, transmitting a third incoming solar light beam having an S-polarization component, the third incoming light beam containing substantially all of the S-polarization component in the second incoming solar light beam received from the infrared reflective waveplate.

In still another embodiment, reflecting in the dual brightness enhancement film substantially all of the P-polarization component of the second incoming light beam comprises deflecting the P-polarization component towards a light absorber of the head-up display.

In yet another embodiment, the further comprises, in a polarization preserving diffuser, receiving the third incoming solar light beam having the S-polarization component from the dual brightness enhancement film, and transmitting a first outgoing beam having an S-polarization component and a P-polarization component.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an exemplary vehicle system that includes a head-up display (HUD) according to an embodiment of the present disclosure.

FIG. 2 is a block diagram of the exemplary HUD illustrating the operation of the HUD according to an embodiment of the present disclosure.

FIG. 3 illustrates a light path of model sunlight reaching a diffuser of the HUD according to an embodiment of the present disclosure.

FIG. 4 illustrates back reflection reduction of the exemplary HUD according to an embodiment of the present disclosure.

FIG. 5 illustrates light loss analysis of the exemplary HUD according to an embodiment of the present disclosure.

In the drawings, reference numbers may be reused to identify similar and/or identical elements.

### DETAILED DESCRIPTION

The present disclosure describes a head-up display (HUD) that includes a novel compact optical stack incorporating both polarization selective characteristics, wavelength selective components, and proper installation angles to mitigate the risk of solar damage on the diffuser of the HUD. The same optical stack is effective for reducing the back reflection and improving image contrast. The polarization and wavelength selective components reduce the solar load on the diffuser at the PGU image plane and reduce the sunlight back reflection from the diffuser, which would enter the eye of the driver.

The novel optical stack mitigates excessive diffuser temperatures due to solar loading and back reflections for high magnification HUD designs. Typical HUDs having a magnification of M=6 or less may not exhibit these issues. However, these issues arise if magnification increases dramatically to reduce the volume of the HUD. The disclosed HUD uses a unique configuration of components to minimize solar load and back reflection in high magnification to achieve certain objectives.

First, the HUD reflects both the S-polarization and P-polarization of the infrared radiation to a safe absorber using a multilayer dielectric thin film reflector coated onto a waveplate. The disclosed HUD also reflects the P-polarization of the visible radiation onto the safe absorber using a tilted component called DBEF, which is a multilayer filter design to transmit S-polarization and reflect P-polarization. These two elements enable safe temperatures even in regions with powerful summer sunlight (e.g., Arizona).

The disclosed HUD also enable high picture generating unit (PGU) efficiency via use of a diffuser that preserves the S-polarization of the PGU transmitted light, since any P-polarization created at the diffuser will not pass through the tilted DBEF. The S- and P-polarizations are a conventional coordinate system that relates to the plane of incidence. The component of the electric field parallel to this plane is termed P (parallel) and the component perpendicular to this plane is termed S (from the German word “senkrecht” for “perpendicular”). Polarized light with an electric field along the plane of incidence is denoted P-polarization, while light with an electric field normal to the plane of incidence is denoted S-polarization. Because half of the visible light entering the HUD is reflected before arriving at the diffuser and diffuser backscatter is minimal, relatively less visible light is scattered back into the eye of the driver.

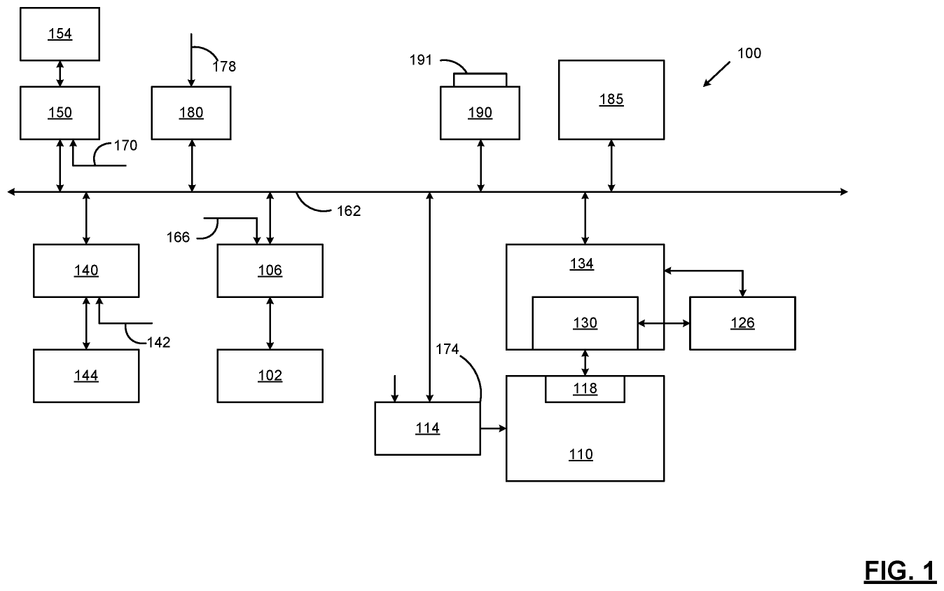

FIG. 1 is a functional block diagram of an exemplary vehicle system 100 that includes a head-up display (HUD) 190 according to an embodiment of the present disclosure. While a vehicle system for a manually driven hybrid vehicle is shown and described, the present disclosure is also applicable to autonomously driven vehicles and to all-electric vehicles that contain a head-up display. The present application may also be applicable to non-automobile implementations, such as trains, boats and aircraft.

An engine 102 combusts an air/fuel mixture to generate drive torque. An engine control module (ECM) 106 controls the engine 102 based on one or more driver or vehicle inputs. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system 100 may include one or more electric motors. For example, an electric motor 118 may be implemented within the transmission 110 as shown in the example of FIG. 1A. An electric motor can act as either a generator or as a motor at a given time. When acting as a generator, an electric motor converts mechanical energy into electrical energy. The electrical energy may charge a battery 126 via a power control device (PCD) 130. When acting as a motor, an electric motor generates torque that supplements or replaces torque output by the engine 102. While the example of one electric motor is provided, the vehicle may include zero or more than one electric motor.

A power inverter control module (PIM) 134 may control the electric motor 118 and the PCD 130. The PCD 130 applies (e.g., direct current) power from the battery 126 to the (e.g., alternating current) electric motor 118 based on signals from the PIM 134, and the PCD 130 provides power output by the electric motor 118, for example, to the battery 126. The PIM 134 may be referred to as a power inverter module (PIM) in various implementations.

A steering control module 140 controls steering/turning of wheels of the vehicle, for example, based on driver turning of a steering wheel within the vehicle and/or steering commands from one or more vehicle control modules. A steering wheel angle sensor (SWA) monitors rotational position of the steering wheel and generates a SWA 142 signal based on the position of the steering wheel. As an example, the steering control module 140 may control vehicle steering via an EPS motor 144 based on the SWA 142 signal. However, the vehicle may include another type of steering system. An electronic brake control module (EBCM) 150 may selectively control brakes 154 of the vehicle.

Modules of the vehicle may share parameters via a controller area network (CAN) 162. The CAN 162 may also be referred to as a car area network. For example, the CAN 162 may include one or more data buses. Various parameters may be made available by a given control module to other control modules via the CAN 162.

The driver inputs may include, for example, an accelerator pedal position (APP) 166 that may be provided to the ECM 106. A brake pedal position (BPP) 170 may be provided to the EBCM 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

According to an exemplary embodiment of the present disclosure, the vehicle system 100 further comprises advanced computing module 185 and head-up display (HUD) 190. As will be explained in greater detail below, HUD 190 further comprises a window (or lens) 191 through which light is projected onto the windshield (not shown) of the vehicle system 100.

The advanced computing module 185 comprises a high performance computing platform that controls many of the higher order functions and lower order functions of the vehicle system 100. In a typical implementation, the advanced computing module 185 may be implemented as a microprocessor and an associated memory. The advanced computing module 185 executes a kernel program that controls the overall operation of the advanced computing module 185.

According to the principles of the present disclosure, the advanced computing module 185 consumes sensor information from various sensors (not shown) in the vehicle system 100. The sensor information may include, for example, wheel speed data, steering wheel angle sensor data, brake status data, LiDAR system data, radar data, camera images, GPS data, accelerometer data, engine temperature and RPM, and the like to determine the speed, direction, and location of the vehicle system 100.

The advanced computing module 185 processes selected parts of the sensor information to produce useful information for display on the windshield via the HUD 190. For example, the advanced computing module 185 may send to the HUD 190 vehicle speed, engine RPM, engine temperature, fuel status, navigational direction, and the like, that the HUD 190 then projects onto the inner surface of the windshield. This enables the driver to view the projected information while looking straight ahead. The driver does not need to look down at the dashboard, thereby taking his or her eyes off the road, in order to view the projected data.

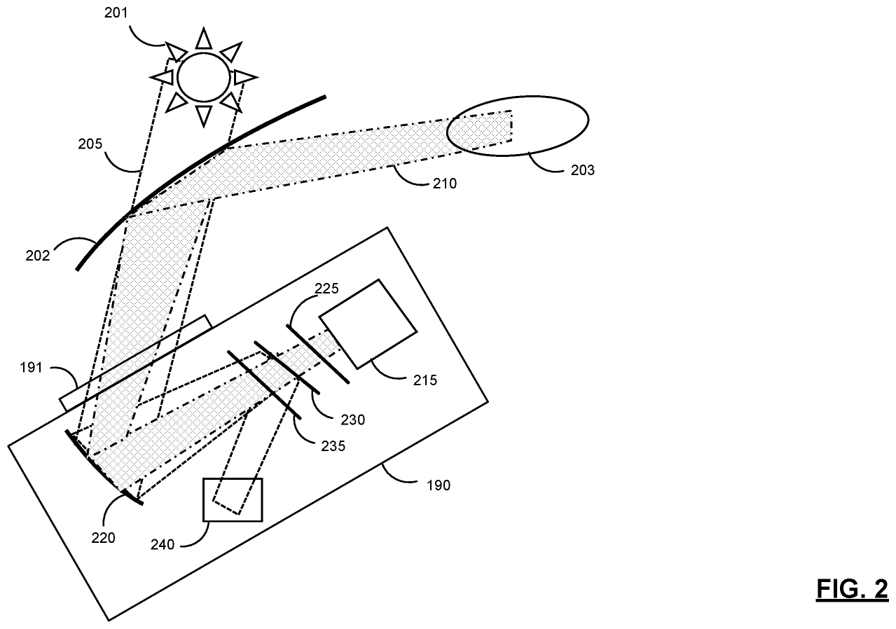

FIG. 2 is a block diagram of the exemplary HUD 190 illustrating the operation of the HUD 190 according to an embodiment of the present disclosure. The HUD 190 comprises a lens 191 that allows light to enter and exit the housing of the HUD 190. The internal components of the HUD 190 comprise a picture generating unit 215, a polarization preserving diffuser 225, a dual brightness enhancement film (DBEF) 230, an infrared (IR) reflective waveplate 235, a mirror 220, and a light absorber 240.

The DBEF 230 is a thin, multi-layer reflective polarizer that includes two diffuse surfaces to provide brightness enhancement and high visual quality. The IR reflective waveplate 235 (also known as a retarder) transmits lights and modifies its polarization state without attenuating, deviating, or displacing the beam. The IR reflective waveplate 235 does this by retarding (or delaying) one component (e.g., S-polarization) of polarization with respect to its orthogonal component (e.g., P-polarization).

FIG. 2 illustrates two light paths. A first light path 205 comprises an incoming solar light beam from the sun 201 that passes through the windshield 202 of the vehicle system 100, enters the lens 191 of the HUD 190, reflects off the mirror 220, passes through the infrared (IR) reflective waveplate 235, and reflects off the DBEF 230 towards the light absorber 240. The boundaries of the first light path 205 are indicated by lines having similar sized dashes. Some of the incoming solar light beam may still pass through the polarization preserving diffuser 225 before entering the PGU 215.

A second light path 210 is an image projected from the PGU unit 215 through the polarization preserving diffuser 225, the DBEF 230, and the IR reflective waveplate 235 before being reflected by the mirror 220 through the lens 191 onto the windshield 202. The windshield 202 further reflects the PGU light into an eyebox 203, which represents the region of the eyes of the driver. Lines having alternating dots and dashes indicate the boundaries of the second light path 210. A crosshatch fill pattern further distinguishes the second light path 210 from the first light path 205.

It is noted that the light paths 205 and 210 are approximately perpendicular to the planes of the polarization preserving diffuser 225 and the IR reflective waveplate 235. However, a plane of the DBEF 230 tilts with respect to the first light path 205 and the second light path 210 so that the light paths 205 and 210 are not perpendicular to the plane of the DBEF 230.

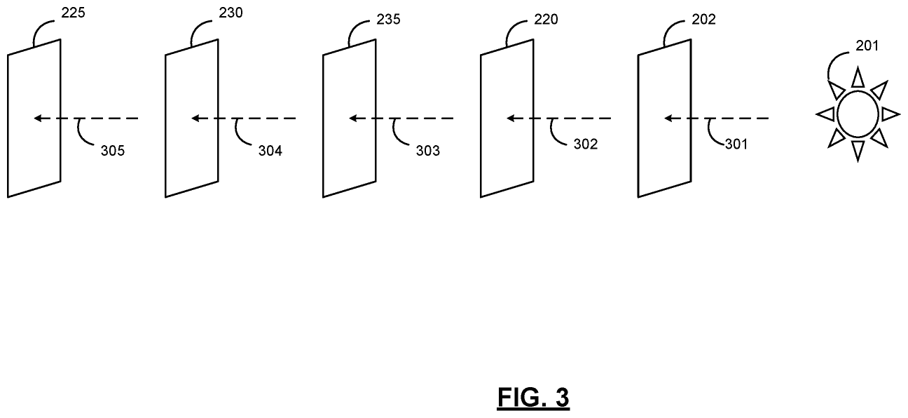

FIG. 3 illustrates a light path of model sunlight reaching the diffuser of the HUD 190 according to an embodiment of the present disclosure. Light path segments 301-305 represent the incoming solar light beam. The incoming solar light beam from the sun 201 is incident on the windshield as the light path segment 301. The light path segment 301 passes through the windshield 202 and may experience some PVB and Fresnel losses to become the light path segment 302. The light path segment 302 reflects off the mirror 220 and may experience some glare trap lens losses to become the light path segment 303. The light path segment 303 then passes through the IR reflective waveplate 235 where additional losses may be experienced and becomes the light path segment 304.

The unpolarized IR light in the light path segment 303 is polarized in the light path segment 304 by the IR reflecting waveplate 235 into 50% S-polarization light and 50% P-polarization light. The light path segment 304 then passes through the DBEF 230 and becomes the light path segment 305. In the light path segment 305, the DBEF 230 reduces nearly all of the P-polarization luminance of the light path segment 304 and some of the S-polarization luminance as well. The polarization preserving diffuser 225 then partially absorbs the light path segment 305. With the optical stack, the temperature of the diffuser after absorbing light path segment 305 is well controlled to a temperature that is lower than the glass transition temperature of the diffuser material.

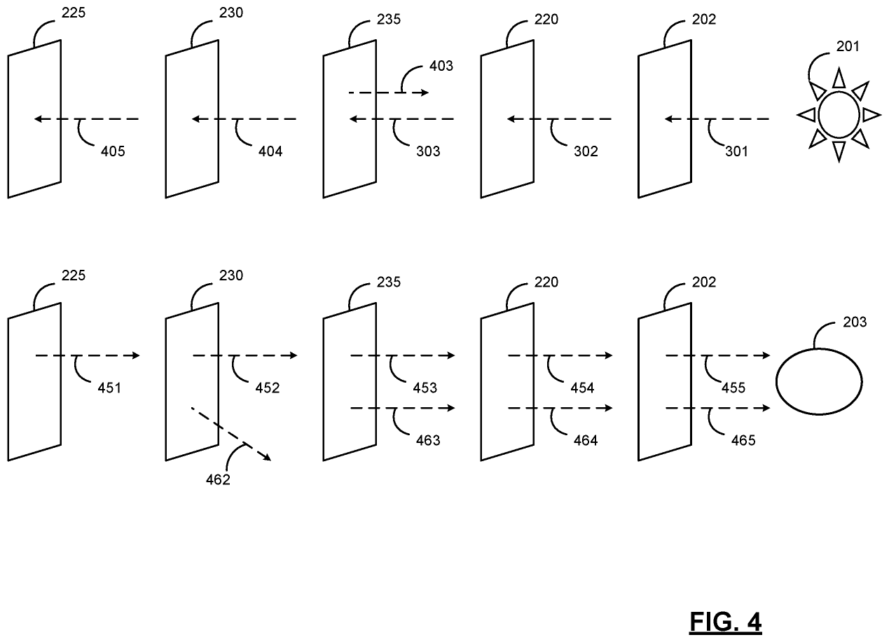

FIG. 4 illustrates back reflection reduction of the exemplary HUD 190 according to an embodiment of the present disclosure. The light path segments 301-303 and the light path segments 404 and 405 represent the incoming solar light beam from the sun 201. The light path segments 301-303 are the same as in FIG. 3. The IR reflective waveplate 235 reflects the infrared component 403 of the incoming solar light beam. The IR reflective waveplate 235 transforms the unpolarized light in the light path segment 303 into polarized light in the light path segment 404, which comprises 50% S-polarization luminance and 50% P-polarization luminance. However, after passing through the DBEF 230, the light path segment 405 comprises only the S-polarization light.

The polarization preserving diffuser 225 reflects about 5% of the light in the light path segment 405 back towards the windshield 202 in the light path segment 451. The polarization preserving diffuser 225 reflects back the light path segment 451 as, for example, 70% S-polarization luminance and 30% P-polarization luminance. The DBEF 230 tilts at an angle to reflect the P-polarization in the light path segment 462 toward the light absorber 240. However, the DBEF 230 transmits the S-polarization light in the light path segment 452 toward the IR reflective waveplate 235. The IR reflective waveplate 235 then transforms the 100% S-polarization light in the light path segment 452 to become the light path segment 453 (25% P-polarization luminance) and the light path segment 463 (75% S-polarization luminance).

The mirror 220 reflects approximately 100% of the light path segment 453 as the light path segment 454 and 100% of the light segment 463 as the light path segment 464 to the windshield 202. The windshield 202 then reflects approximately 3% of the P-polarization luminance in the light path segment 454 as the light path segment 455. The windshield 202 also reflects approximately 20% of the S-polarization luminance in the light path segment 464 as the light path segment 465. The windshield 202 reflects the light path segments 455 and 465 toward the eyebox 203.

Without the DBEF 230 and the IR reflecting waveplate 235, the back reflection from a conventional diffuser reflecting, for example, 8% unpolarized light, may cause a reflected luminance of 325.1 cd/m² at the eyebox 203. However, because the disclosed HUD 190 includes the novel combination of the polarization preserving diffuser 225, the tilted DBEF 230, and the IR reflecting waveplate 235, the reflected luminance may be reduced to a reflected luminance of 219.1 cd/m² at the eyebox 203. This represents a 32.6% reduction in the back-reflected light.

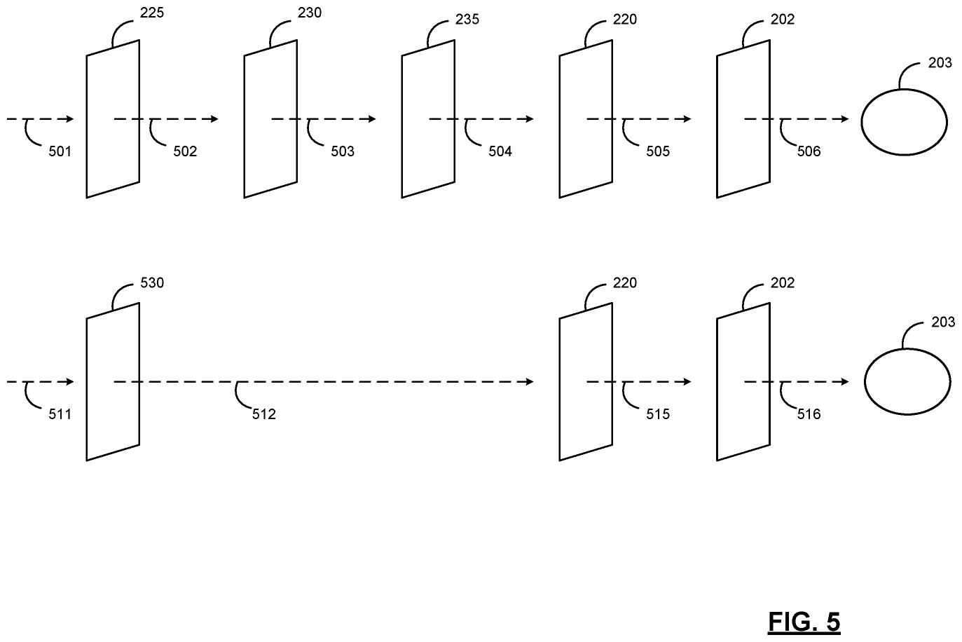

FIG. 5 illustrates light loss analysis of the exemplary HUD 190 according to an embodiment of the present disclosure. The light path segments 501-506 represent the light of an image projected from the PGU 215 to the eyebox 203. The projected light from PGU 215 is incident on the polarization preserving diffuser 225 as the light path segment 501. It is assumed that the light path segment 501 has a luminance of 75,000 cd/m² and 100% S-polarization. The polarization preserving diffuser 225 produces the light path segment 502, which may have, for example, 5% P-polarization and 95% S-polarization.

The DBEF 230 eliminates the P-polarization from the light path segment 502 and transmits the light segment 503 with 100% S-polarization towards the IR reflective waveplate 235. The IR reflective waveplate 235 then rotates the 100% S-polarization light in the light path segment 503 to become the light path segment 504, which may comprise 25% P-polarization luminance and 75% S-polarization luminance. The mirror 220 reflects 100% of the light path segment 504 as light path segment 505, which is transmitted to the windshield 202. Finally, the windshield 202 reflects the light path segment 505 as light path segment 506, which is transmitted to the eyebox 203. The light path segment 506 may comprise 20% S-polarization luminance and 3% P-polarization luminance.

In this manner, the eyebox 203 receives the initial light path segment 501, which may have an exemplary luminance of 75,000 cd/m², as the light path segment 506, which may have an S-polarization luminance of 9,455.6 cd/m² and a P-polarization luminance of 472.8 cd/m². The combined luminance of the S- and P-polarization light is then 9,928.4 cd/m².

In the bottom half of FIG. 5, the light losses are presented based on the assumption that the diffuser 530 is not a polarization preserving diffuser and that the DBEF 230 and the IR reflective waveplate 235 are not present in the optical stack. A conventional diffuser 530. The projected light from PGU 215 is incident on the conventional diffuser 530 as the light path segment 511. It is assumed that the light path segment 511 has a luminance of 75,000 cd/m² and 100% S-polarization as before. The diffuser 530 produces the light path segment 512, which may have, for example, 30% P-polarization and 70% S-polarization. The mirror 220 reflects 100% of the light path segment 512 as light path segment 515, which is transmitted to the windshield 202. The windshield 202 reflects the light path segment 515 as light path segment 516, which is transmitted to the eyebox 203. The light path segment 516 may comprise 20% of the S-polarization light and 3% of the P-polarization light.

In this manner, the eyebox 203 receives the initial light path segment 511, which may have an exemplary luminance of 75,000 cd/m², as the light path segment 516, which may have an S-polarization luminance of 10,500 cd/m² and a P-polarization luminance of 675 cd/m². The combined luminance of the S- and P-polarization light is then 11,175 cd/m².

Thus, the optical stack at the top of FIG. 5, which includes the polarization preserving diffuser 225, the DBEF 230, and the IR reflective waveplate 235, may cause an 11% luminance loss (i.e., 9,928.4 cd/m² vs. 11,175 cd/m²). However, this is still close to a target luminance of 10,000 cd/m² for HUD 190.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. It should also be understood that steps in the embodiments can also be eliminated. For instance, all of the routing based assessments and actions can be eliminated so that only buckling and possibly occupancy are monitored and acted upon with actions.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A head-up display comprising:
a picture generating unit configured to project an image onto a polarization-preserving diffusing surface; and
an optical stack comprising:
an infrared reflective waveplate; and
a dual brightness enhancement film,
wherein the infrared reflective waveplate reflects an infrared portion of a first incoming solar light beam and transmits a second incoming solar light beam having an S-polarization component and a P-polarization component.

2. The head-up display of claim 1, wherein the dual brightness enhancement film receives the second incoming solar light beam from the infrared reflective waveplate and reflects substantially all of the P-polarization component of the second incoming solar light beam.

3. The head-up display of claim 2, wherein the dual brightness enhancement film transmits substantially all of the S-polarization component received from the infrared reflective waveplate as a third incoming solar light beam having an S-polarization component.

4. The head-up display of claim 3, wherein the head-up display comprises a light absorber.

5. The head-up display of claim 4, wherein the dual brightness enhancement film reflects substantially all of the P-polarization component by deflecting the P-polarization component towards the light absorber.

6. The head-up display of claim 5, wherein a plane of the dual brightness enhancement film is tilted with respect to the direction of the second incoming solar light beam.

7. The head-up display of claim 6, further comprising a polarization preserving diffuser configured to receive the third incoming solar light beam having the S-polarization component from the dual brightness enhancement film and to transmit a first outgoing beam having an S-polarization component and a P-polarization component.

8. The head-up display of claim 7, wherein the S-polarization component of the first outgoing beam is significantly larger than the P-polarization component of the first outgoing beam.

9. The head-up display of claim 8, wherein the dual brightness enhancement film receives the first outgoing beam from the polarization preserving diffuser and eliminates substantially all of the P-polarization component of the first outgoing beam.

10. The head-up display of claim 9, wherein the dual brightness enhancement film transmits substantially all of the S-polarization component of the first outgoing beam as a second outgoing beam.

11. The head-up display of claim 10, wherein the dual brightness enhancement film eliminates substantially all of the P-polarization component of the first outgoing beam by deflecting the P-polarization component of the first outgoing beam towards the light absorber.

12. The head-up display of claim 11, wherein the infrared reflective waveplate receives the second outgoing beam from the dual brightness enhancement film and transmits a third outgoing beam having an S-polarization component and a P-polarization component.

13. The head-up display of claim 12, wherein the S-polarization component of the third outgoing beam is significantly larger than the P-polarization component of the third outgoing beam.

14. A method of reducing solar load in a head-up display comprising a picture generating unit configured to project an image onto a polarization-preserving diffusing surface, the method comprising:
in an optical stack comprising an infrared reflective waveplate and a dual brightness enhancement film:
reflecting by the infrared reflective waveplate an infrared portion of a first incoming solar light beam; and
transmitting by the infrared reflective waveplate a second incoming solar light beam having an S-polarization component and a P-polarization component.

15. The method of claim 14, further comprising:
receiving in the dual brightness enhancement film the second incoming solar light beam from the infrared reflective waveplate; and
reflecting in the dual brightness enhancement film substantially all of the P-polarization component of the second incoming light beam.

16. The method of claim 15, further comprising:
in the dual brightness enhancement film, transmitting a third incoming solar light beam having an S-polarization component, the third incoming light beam containing substantially all of the S-polarization component in the second incoming solar light beam received from the infrared reflective waveplate.

17. The method of claim 16, wherein reflecting in the dual brightness enhancement film substantially all of the P-polarization component of the second incoming light beam comprises deflecting the P-polarization component towards a light absorber of the head-up display.

18. The method of claim 17, wherein a plane of the dual brightness enhancement film is tilted with respect to the direction of the second incoming solar light beam.

19. The method of claim 18, further comprising:
in a polarization preserving diffuser:
receiving the third incoming solar light beam having the S-polarization component from the dual brightness enhancement film; and
transmitting a first outgoing beam having an S-polarization component and a P-polarization component.

20. The method of claim 19, wherein the S-polarization component of the first outgoing beam is significantly larger than the P-polarization component of the first outgoing beam.
